(19) United States
(12) Patent Application Publication
(10) Pub. No.: US 2025/0124763 A1
(43) Pub. Date: Apr. 17, 2025

(54) System and Method for Providing Awards based on a Dynamic Slider

(71) Applicant: Grover Gaming, Inc., Greenville, NC (US)

(72) Inventors: Kevin Mandeville, Wilmington, NC (US); Wes Owens, Wilmington, NC (US)

(73) Assignee: Grover Gaming, Inc., Greenville, NC (US)

(21) Appl. No.: 18/908,991

(22) Filed: Oct. 8, 2024

Related U.S. Application Data
(60) Provisional application No. 63/543,580, filed on Oct. 11, 2023.

(51) Int. Cl. G07F 17/32; G06F 3/04847; G06F 3/0488

(52) U.S. Cl. CPC G07F 17/3265; G06F 3/04847; G06F 3/0488; G07F 17/3209; G07F 17/3267

(57) ABSTRACT

A method of determining an award amount. The method may include initiating a game play of a game on a game machine; receiving an outcome of the game play; automatically activating an awards slider component if the outcome of the game play is a winning outcome, wherein the winning outcome includes an associated award amount, and wherein activating the awards slider component causes animation of a dynamic slider feature graphic including an indicator dynamically moving along or about a slider scale on a display; and interacting with the dynamic slider feature graphic to determine a percentage of the award amount to be awarded, wherein the percentage of the award amount to be awarded is entirely determined by a stop position of the indicator of the dynamic slider feature graphic on the slider scale upon interacting with the dynamic slider feature.

### RELATED APPLICATIONS

This application is related and claims priority to U.S. Provisional Patent Application No. 63/543,580, filed on Oct. 11, 2023 the application of which is incorporate herein by reference in its entirety.

### TECHNICAL FIELD

The subject matter of the invention relates generally to gaming systems and more particularly to a gaming system and method for providing awards based on a dynamic slider.

### SUMMARY

In one embodiment, a method of determining an award amount. The method may include initiating a game play of a game on a game machine; receiving an outcome of the game play; automatically activating an awards slider component if the outcome of the game play is a winning outcome, wherein the winning outcome includes an associated award amount, and wherein activating the awards slider component causes animation of a dynamic slider feature graphic including an indicator dynamically moving along or about a slider scale on a display; and interacting with the dynamic slider feature graphic to determine a percentage of the award amount to be awarded, wherein the percentage of the award amount to be awarded is entirely determined by a stop position of the indicator of the dynamic slider feature graphic on the slider scale upon interacting with the dynamic slider feature. The indicator may include a slider pointer. The slider scale may include a defined percentage range. Interacting with the dynamic slider feature graphic may include actuating a user input, wherein actuating the user input stops the slider pointer at its position on the slider scale at the time the user input was actuated. The user input may include any of one or more buttons and/or a touchscreen. The method may further include a timer, and wherein activating the awards slider component starts the timer, and the user input must be actuated within a set period of time or the entire award amount is forfeited. The slider pointer moves continuously along or about the slider scale until actuating the user input or expiration of the set period of time on the timer. The slider scale may be arranged in one of a horizontal, vertical, or rotary fashion. Initiating the game play may include adding an amount of consideration to the game machine via a consideration input device. Whether or not the awards slider component is automatically activated is solely dependent on the outcome of the initiated game play of the game. The game machine may include one or more of a display, one or more user inputs, consideration input/payout device, a speaker, a ticket reader, a swipe/dunk card reader, and/or a ticket printer.

In another embodiment, a system for determining an award amount is provided. The system may include a game machine; a display associated with the game machine; one or more user inputs associated with the game machine, wherein the one or more user inputs may include either or both of a user input touch screen integrated with the display and/or one or more user input buttons, and wherein the one or more user input buttons may include one or more of buttons, switches, dials, touch pad/surface, mouse, and/or joy stick; a consideration input/payout device associated with the game machine, wherein the consideration input/payout device may be configured to accept consideration input from a user and/or dispense an award; an awards slider component; one or more controllers, wherein the one or more controllers are associated with one or more processors and associated with the display, the user inputs, the awards slider component, and the consideration/payout input device, and wherein the one or more processors may include non-transitory computer readable medium including executable program code stored thereon. Upon execution of the executable program code the processors may be configured to initiate a game play of a game; receive an outcome of the game play; automatically activate the awards slider component if the outcome of the game play is a winning outcome, wherein the winning outcome may include an associated award amount, and wherein activating the awards slider component causes animation of a dynamic slider feature graphic, including an indicator, dynamically moving along or about a slider scale on the display; and receive a command interacting with the dynamic slider feature graphic to determine a percentage of the award amount to be awarded, wherein the command updates the display to cause the animation of the indicator of the dynamic slider feature graphic dynamically moving along or about the slider scale to stop at its current position along or about the slider scale, wherein the percentage of the award amount to be awarded is entirely determined by the position of the indicator where it was stopped on the slider scale. The indicator may include a slider pointer. The slider scale may include a defined percentage range. Interacting with the dynamic slider feature graphic may include activating one or more of the one or more user inputs, wherein activating one or more of the one or more user inputs stops the slider pointer at its current position on the slider scale at the time one or more of the one or more user input was activated. The system may further include a timer, and wherein upon activating the awards slider component the timer is started, and the user input must be actuated within a set period of time or the entire award amount is forfeited. The slider pointer may move continuously along or about the slider scale until actuating the user input or expiration of the set period of time on the timer. The system may further include one or more of a speaker, a ticket reader, a swipe/dunk card reader, and/or a ticket printer. The slider scale may be arranged in one of a horizontal, vertical, or rotary fashion. Whether or not the awards slider component is automatically activated is solely dependent on the outcome of the initiated game play of the game.

### BACKGROUND

For games of chance, a player's engagement or interest in a game can determine a game's success. In typical games of chance, a player is required to spend some form of consideration prior to the start of a game play. Additionally, the player has no prior knowledge of what the result will be of the next game play. Only one final result will be presented to the player after the player's consideration has been spent. No matter how the final result of a game play is generated, the player is chancing their consideration against a result that is not known to them prior to the play. Therefore, players are taking a chance on the outcome of the game.

In the gaming industry, there is always desire to provide greater excitement and entertainment levels for the participants. Accordingly, in gaming systems there is a continuous need to provide new features for increasing a player's engagement or interest in the game.

### BRIEF DESCRIPTION OF THE DRAWINGS

Having thus described the subject matter of the invention in general terms, reference will now be made to the accompanying drawings, which are not necessarily drawn to scale, and wherein:

FIG. 1 illustrates a block diagram of an example of a system for providing awards based on a dynamic slider feature, in accordance with an embodiment of the invention;

FIGS. 2, 3, and FIG. 4 illustrate screenshots of an example of game graphics including a dynamic slider feature for determining the game award, in accordance with an embodiment of the invention;

FIG. 5A through FIG. 7 illustrate screenshots of examples of dynamic sliders for determining the game award, in accordance with an embodiment of the invention;

FIG. 8 illustrates a screenshot of the game graphics shown in FIG. 2 and including a specific example of a dynamic slider for determining the game award, in accordance with an embodiment of the invention;

FIG. 9 illustrates a screenshot of the game graphics shown in FIG. 3 and including a specific example of a dynamic slider for determining the game award, in accordance with an embodiment of the invention; and

FIG. 10 illustrates a flow diagram of an example of a method of using the gaming system for providing awards based on a dynamic slide, in accordance with an embodiment of the invention.

### DETAILED DESCRIPTION

The subject matter of the invention now will be described more fully hereinafter with reference to the accompanying drawings, in which some, but not all embodiments of the subject matter of the invention are shown. Like numbers refer to like elements throughout. The subject matter of the invention may be embodied in many different forms and should not be construed as limited to the embodiments set forth herein; rather, these embodiments are provided so that this disclosure will satisfy applicable legal requirements. Indeed, many modifications and other embodiments of the subject matter of the invention set forth herein will come to mind to one skilled in the art to which the subject matter of the invention pertains having the benefit of the teachings presented in the foregoing descriptions and the associated drawings. Therefore, it is to be understood that the subject matter of the invention is not to be limited to the specific embodiments disclosed and that modifications and other embodiments are intended to be included within the scope of the appended claims.

In some embodiments, the subject matter of the invention provides a gaming system and method for providing awards based on a dynamic slider. For example, a gaming system and method are provided that may include, for example, a gaming application further including an awards slider component running on a centralized server. Further, the gaming system may be connected to a plurality of electronic gaming machines (EGMs) for playing, for example, games of chance and/or games of skill.

In some embodiments, a gaming system and method may provide a gaming application at a centralized server that supports a platform for using EGMs.

In some embodiments, a gaming system and method may provide a gaming application at a centralized server and wherein the gaming application may further include a dynamic slider feature for determining the game award.

In some embodiments, a gaming system and method may provide a gaming application that may include a dynamic slider feature and wherein the dynamic slider feature may be used on games of chance only, on games of skill only, or on both games of chance and games of skill.

In some embodiments, a gaming system and method may provide a gaming application that may include a dynamic slider feature for determining the game award and wherein the chances of a player being successful using the dynamic slider feature may be wholly independent of the underlying, or primary, game.

Further, a method of using a gaming system including a dynamic slider feature for determining the game award may be provided.

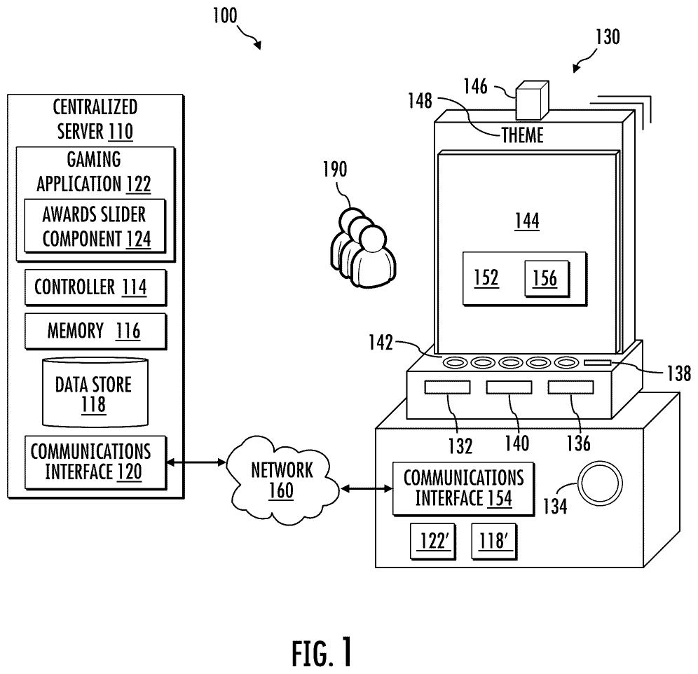

Referring now to FIG. 1 is a block diagram of an example of a gaming system 100 for providing awards based on a dynamic slider feature, in accordance with an embodiment of the invention. For example, gaming system 100 may include a dynamic slider feature for determining the game award.

Gaming system 100 may include, for example, a centralized server 110 connected to one or more EGMs 130 via a network 160. Further, a plurality of players 190 may be associated with gaming system 100. For example, players 190 may use EGMs 130 with respect to wagering activities on games of chance. Players 190 may include, for example, individuals, groups of individuals, entities, and/or groups of entities.

Centralized server 110 may further include a controller 114 that may include a certain amount of operating memory 116, a data store 118, a communications interface 120, and a gaming application 122. Controller 114 may be any standard controller or microprocessor device that is capable of executing program instructions. Controller 114 may be used to manage the overall operations of gaming system 100. Memory 116 may be any volatile or non-volatile memory device. Memory 116 may be built into or separate from controller 114. Data store 118 may be, for example, data repositories (like databases) and/or flat files that can store data. In one example, data store 118 may be a Structured Query Language (SQL) database. Further, gaming system 100 is not limited to one data store 118 only. Gaming system 100 may include multiple data stores 118.

EGMs 130 may be, for example, any electronic gaming machine (EGM) or terminal, casino gaming machine or terminal, such as a slot machine style terminal, or any virtual gaming terminal found online. In one example, EGMs 130 may be implemented as mobile apps for smart devices, such as smartphones and tablet devices.

Generally, EGM 130 may include, for example, any one or more of a bill/consideration acceptor 132, a speaker 134, a ticket reader 136, a swipe card or dunk card reader 138, a ticket printer 140, a custom button panel 142 to allow the player 190 to interact with EGM 130, a display screen 144, which may or may not include touchscreen capability, a specialized lighting effect mechanism 146, and a sign 148 signifying the games of chance that can be wagered on. Additionally, each EGM 130 may include certain game graphics 152 that may be driven to display screen 144. Further, each EGM 130 may include a communications interface 154. Additionally, each EGM 130 may be clearly marked as to the type of gaming experience they represent by displaying graphics and/or signage denoting the contests, pools, and/or wagers they will provide.

In one example, gaming system 100 may be implemented using a client-server architecture in which centralized server 110 is the server and the EGMs 130 are the clients. Accordingly, gaming application 122 and data store 118 at centralized server 110 may represent the server side of the client-server architecture and gaming application 122′ and data store 118′ at EGMs 130 represents the client side of the client-server architecture. Centralized server 110 may be, for example, an application server. Centralized server 110 can be any networked computing configuration as long as it is accessible via network 160 by EGMs 130 that may be operated by players 190. For example, gaming system 100, and more particularly gaming application 122, may support a cloud computing environment. In a cloud computing environment, centralized server 110 may be the cloud server. Further, gaming application 122 is not limited to running on one centralized server 110 only. Gaming system 100 may include multiple centralized servers 110 (or cloud servers) in order to ensure high-availability of computing resources.

Accordingly, the control software for each of the EGMs 130 may be based on a gaming application 122′ and a data store 118′ at each EGM 130. For example, gaming application 122′ and data store 118′ may be the software components at EGMs 130 that are the counterparts to the gaming application 122 and data store 118 at centralized server 110.

Network 160 may be, for example, a local area network (LAN) and/or a wide area network (WAN) for connecting to the Internet or to an Intranet. Centralized server 110 and each EGM 130 may connect to network 160 by any wired and/or wireless means. For example, centralized server 110 may connect to network 160 via communications interface 120 and each EGM 130 may connect to network 160 via its communications interface 154.

Both the communications interface 120 at centralized server 110 and the communications interface 154 at each of the EGMs 130 may be any wired and/or wireless communication interface for connecting to a network (e.g., network 160) and by which information may be exchanged with other devices connected to the network. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+ (Advanced Network Tools) technology, radio frequency (RF), Infrared Data Association (IrDA) compatible protocols, Local Area Networks (LAN), Wide Area Networks (WAN), Shared Wireless Access Protocol (SWAP), any combinations thereof, and other types of wireless networking protocols.

EGMs 130 may be configured as an electronic gaming device, such as, but not limited to, a slot machine, a video lottery terminal, an electronic pull-tab device, a historical horse racing device, a no chance gaming device, or a skill game device.

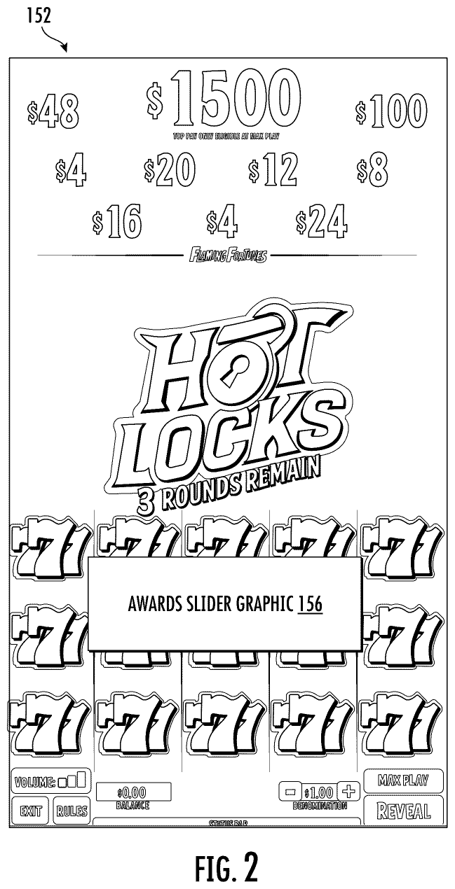

Generally, gaming application 122 at centralized server 110 may be a software and/or hardware application that supports a platform for using EGMs 130. Further, gaming application 122 may include an awards slider component 124 (e.g., a software component or module). Awards slider component 124 supports an awards slider graphic 156 at EGMs 130. For example, awards slider component 124 and awards slider graphic 156 support a dynamic slider feature for determining the game award. Non-limiting examples of awards slider graphics 156 are shown and described below with reference to FIG. 2A through FIG. 8.

Interactive games or features may be added to or overlaid on underlying, or primary, games of skill and/or games of chance to, among other things, engage a player or otherwise build or keep a player's interest in an overall game. In gaming system 100, awards slider component 124 of gaming application 122 at centralized server 110 and awards slider graphic 156 at EGMs 130 may provide an interactive game or feature that may be added to or overlaid on an underlying, or primary, game and presented to a player after the player wins the underlying, or primary, game on an electronic gaming device, such as, but not limited to, a slot machine, a video lottery terminal, an electronic pull-tab device, a historical horse racing device, a no chance gaming device, or a skill game device.

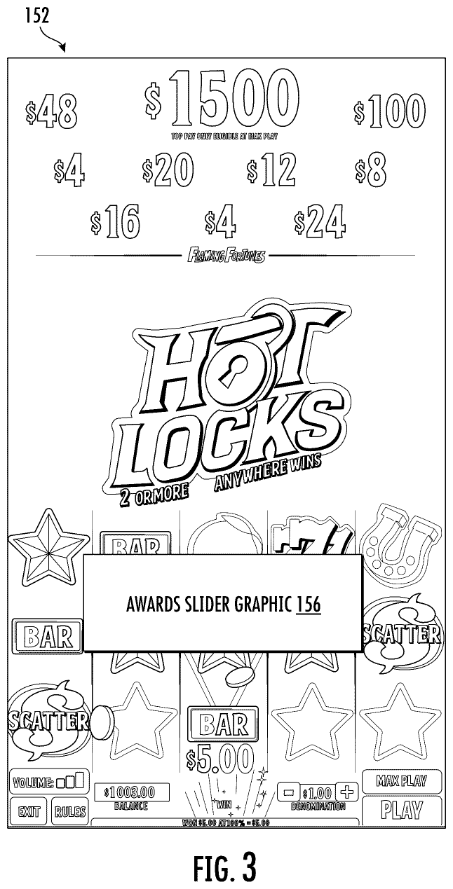

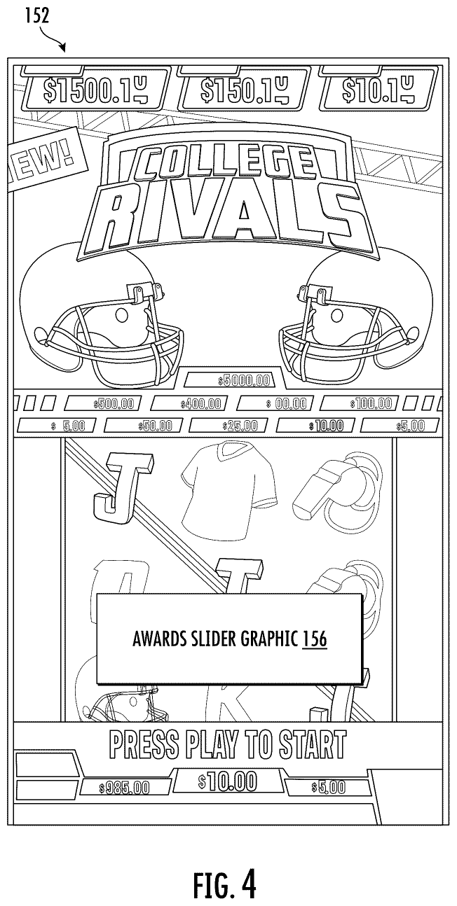

By way of example, FIG. 2 shows a screenshot of an example of game graphics 152 including an awards slider graphic 156 that provides a dynamic slider feature for determining the game prize amount awarded. FIG. 3 shows a screenshot of another example of game graphics 152 including awards slider graphic 156 that provides a dynamic slider feature for determining the game prize amount awarded. FIG. 4 shows a screenshot of yet another example of game graphics 152 including awards slider graphic 156 that provides a dynamic slider feature for determining the game prize amount awarded.

For example, awards slider component 124 and awards slider graphic 156 support an interactive game or feature that determines what percentage of a potential prize that was attained during the underlying, or primary, game the player will receive. In one embodiment, awards slider graphic 156 may be presented as a linear slider with an arrow indicator. Awards slider graphic 156 may contain areas corresponding to various percentages.

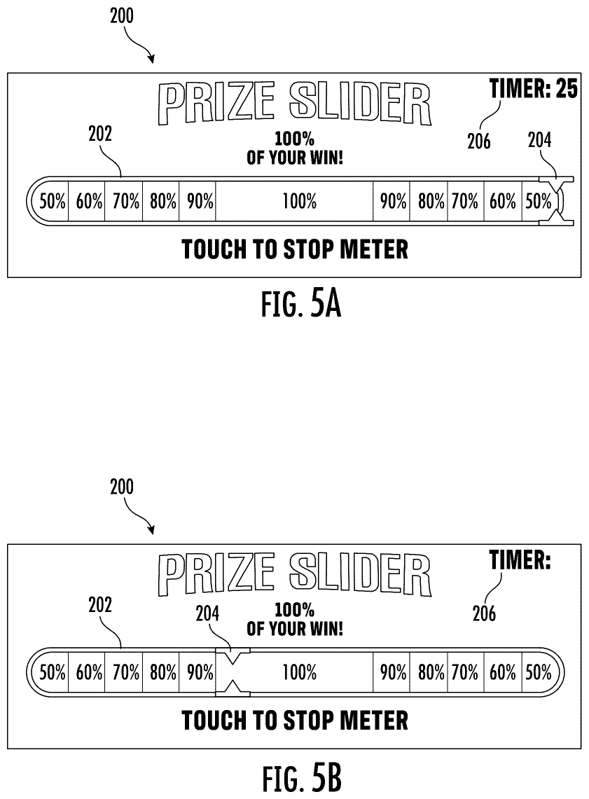

For example, moving from left to right across awards slider graphic 156, awards slider graphic 156 may have areas correspond incrementally from 75% up to 100% and back down to 75%. During the feature, the arrow moves back-and-forth across the linear slider until the player presses a button, or other user input, to stop the arrow on the slider. To receive 100% of the potential prize, the player must stop the arrow in the area of the slider corresponding to 100%, e.g., the center. If the player stops the arrow outside the 100% area, e.g., towards the edge of the awards slider graphic 156, the player will receive less than 100% of the potential prize. In other embodiments, awards slider graphic 156 may be scaled to award a prize greater than 100%, such as 110%. A time limit may be incorporated into the invention, whereby, if time expires, any potential prize is forfeited. The player may be required to participate in the interactive game or feature supported by awards slider component 124 and awards slider graphic 156 to determine the actual prize amount awarded. More details of examples of awards slider graphic 156 are shown and described below with reference to FIG. 5A through FIG. 7.

Awards slider component 124 and awards slider graphic 156 may be used on games of chance only, on games of skill only, on games with no element of chance, or on any one or more games of chance, games of skill, or games with no element of chance. The chances of a player being successful using awards slider component 124 and awards slider graphic 156 may be wholly independent of the underlying, or primary, game. Indeed, the player's ability to stop the arrow in the 100% range is solely determinative of receiving the maximum potential prize.

Referring now to FIG. 5A through FIG. 7 are screenshots of non-limiting examples of awards slider graphics 156 that provide a dynamic slider feature for determining the game award.

For example, FIG. 5A and FIG. 5B show a prize slider 200, which is one example of awards slider graphic 156 shown in FIG. 1 through FIG. 4. Prize slider 200 may include, for example, a slider scale 202, a slider pointer (or arrow) 204, and/or a timer 206. In this example, slider scale 202 is arranged horizontally and indicates a scale from 50% to 100%. FIG. 5A shows prize slider 200 in a beginning or starting state. FIG. 5B shows prize slider 200 in an ending state and showing slider pointer 204 stopped by the player at a certain spot that indicates the percent of prize awarded.

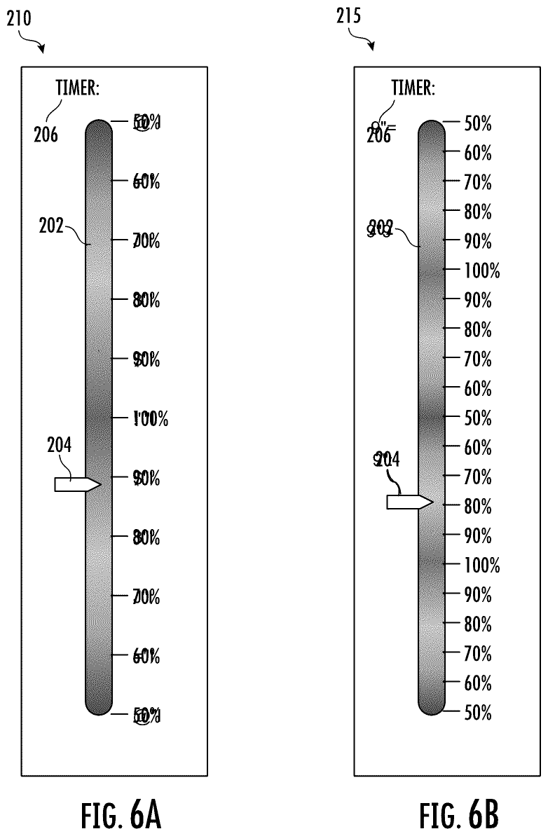

In other examples the slider scale 202 may be arranged vertically. For example, FIG. 6A and FIG. 6B show a prize slider 210 and a prize slider 215, respectively. Prize slider 210 and prize slider 215 are other examples of awards slider graphic 156 shown in FIG. 1 through FIG. 4. In this example, slider scale 202 of prize slider 210 may include one 100% zone, while slider scale 202 of prize slider 215 may include two 100% zones.

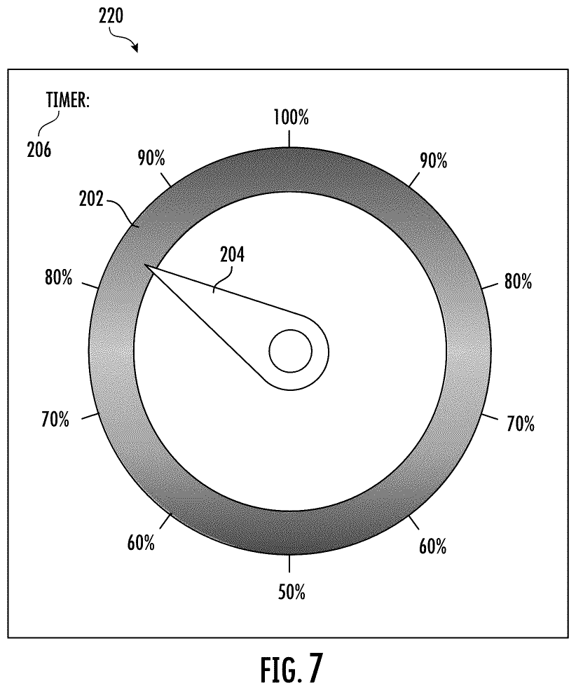

In other examples the slider scale 202 may be arranged in rotary fashion. For example, FIG. 7 shows a prize slider 220, which is yet another example of awards slider graphic 156 shown in FIG. 1 through FIG. 4. Prize slider 220 provides a circular or “speedometer” style of slider. Slider scale 202 may be arranged in rotary fashion and indicates a scale from 50% to 100%.

Referring still to FIG. 5 through FIG. 7, the shape and/or configuration of slider scale 202, the speed of slider pointer (or arrow) 204, the low and high ends of the percentage range, and/or increments of slider scale 202 are all aspects of the invention that may vary. The size and number of the various areas that correspond to the various percentages may also vary. For example, a particular area could range from very broad to very narrow. Still further, the location of the 100% prize area may vary. For example, that area could fall anywhere along the slider or could be broken into multiple areas. That is, rather than being one area in the middle of the slider (e.g., prize slider 210 of FIG. 6A), the 100% area may include two areas along the linear slider scale 202 (e.g., prize slider 215 of FIG. 6B). Further, the maximum prize awarded using the prize slider may be greater than 100%. In one non-limiting example, the scale 202 may range up to 110%.

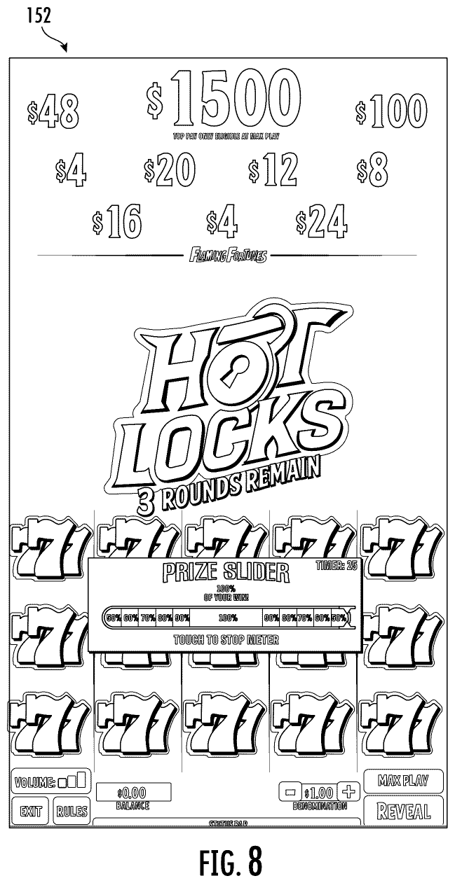

Referring now to FIG. 8 is a screenshot of the game graphics 152 shown in FIG. 2 and including the prize slider 200 shown in FIG. 5A, which is one example of a dynamic slider feature for determining the game award.

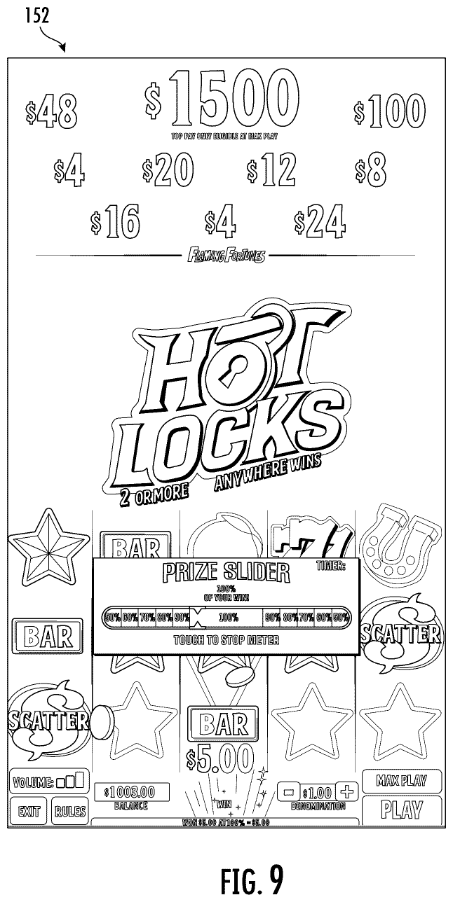

Referring now to FIG. 9 is a screenshot of the game graphics 152 shown in FIG. 3 and including the prize slider 220 shown in FIG. 5B, which is another example of a dynamic slider feature for determining the game award.

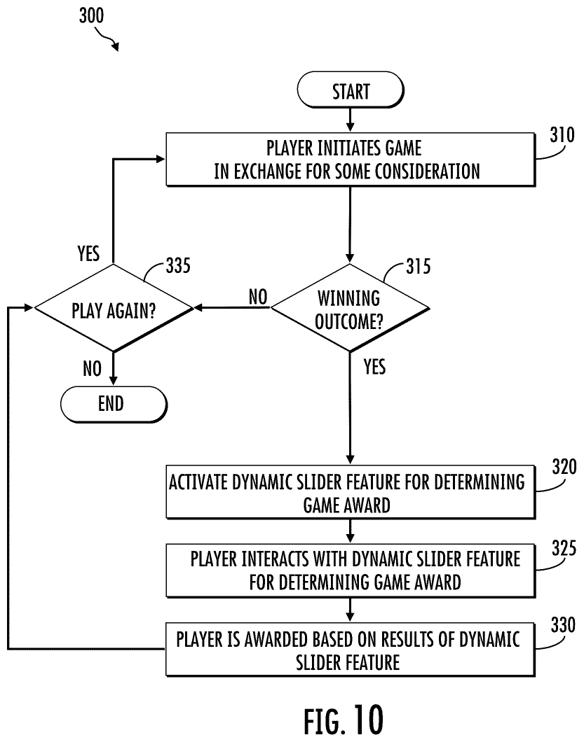

Referring now to FIG. 10 is a flow diagram of an example of a method 300 of using the gaming system 100 including a dynamic slider feature for determining the game award, in accordance with an embodiment of the invention. Method 300 may include, but is not limited to, the following steps.

At a step 310, a player initiates a game. For example and referring now to FIG. 1, a player 190 may use one of the EGMs 130 of gaming system 100 to initiate a game, e.g., a game of chance, a game of skill, and/or a game with no element of chance.

At a decision step 315, it is determined whether there is a winning outcome. For example, gaming application 122 at centralized server 110 may be used to determine whether there is a winning outcome of the game. If there is a winning outcome, then method 300 may proceed to step 320. However, if there is not a winning outcome, then method 300 may proceed to step 335.

At a step 320, the dynamic slider feature for determining the game prize award amount may be activated. For example, the dynamic slider feature that is supported by awards slider component 124 at centralized server 110 and awards slider graphic 156 at the EGM 130 may be activated. More specifically, prize slider 200 as shown in FIG. 5A and FIG. 5B, prize slider 210 shown in FIG. 6A, prize slider 215 shown in FIG. 6B, prize slider 220 shown in FIG. 7, or other style/configuration of prize slider graphic 156, may be activated.

At a step 325, the player interacts with the dynamic slider feature for determining the game award. For example, the player 190 interacts with the awards slider graphic 156 at the EGM 130. More specifically, the player 190 may interact with prize slider 200 shown in FIG. 5A and FIG. 5B, prize slider 210 shown in FIG. 6A, prize slider 215 shown in FIG. 6B, prize slider 220 shown in FIG. 7, or other style/configuration of prize slider graphic 156. The player 190 may interact with prize slider 200, for example, by activating a button on button panel 142 to stop the slider pointer or arrow 204 along the slider scale 202.

At a step 330, the player is awarded based on results of the dynamic slider feature. For example, the player 190 is awarded based on the landing place of awards slider graphic 156 at the EGM 130. For example, based on the landing place of awards slider graphic 156 the player may be awarded some portion of percentage of the full award amount, which could be an amount equal to, greater than, or less than the full award amount.

At a decision step 335, the player determines whether they want to play another game. If the player wishes to play another game, then method 300 may return to step 310. However, if the player does not wish to play another game, then method 300 ends.

In summary, and referring now again to FIG. 1 through FIG. 10, gaming system 100 and method 300 may be used to provide awards based on a dynamic slider feature. For example, gaming system 100 and method 300 provide gaming application 122 further including awards slider component 124 running on centralized server 110. Further, gaming system 100 may be connected to a plurality of EGMs 130 for playing, for example, but not limited to, games of chance, games of skill, and/or games with no element of chance.

In some embodiments, gaming system 100 and method 300 may provide a dynamic slider feature for determining the game award. The dynamic slider feature may be implemented, for example, using awards slider component 124 of gaming application 122 and awards slider graphic 156 at the EGMs 130.

In some embodiments, gaming system 100 and method 300 may provide a dynamic slider feature (e.g., awards slider component 124 of gaming application 122 and awards slider graphic 156) that may be used on games of chance only, on games of skill only, games with no element of chance only, or on any of games of chance, games of skill, and/or games with no element of chance.

In some embodiments, gaming system 100 and method 300 may provide a dynamic slider feature (e.g., awards slider component 124 of gaming application 122 and awards slider graphic 156) for determining the game award and wherein the chances of a player 190 being successful using the dynamic slider feature may be wholly independent of the underlying, or primary, game.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present invention.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the invention will be apparent to the skilled person without departing from the scope and spirit of the invention. Although the subject matter has been disclosed in connection with specific preferred aspects or embodiments, it should be understood that the subject matter as claimed should not be unduly limited to such specific aspects or embodiments.

The subject matter may be implemented using hardware, software, or a combination thereof and may be implemented in one or more computer systems or other processing systems. In one aspect, the subject matter is directed toward one or more computer systems capable of carrying out the functionality described herein.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A method of determining an award amount, the method comprising:
a. initiating a game play of a game on a game machine;
b. receiving an outcome of the game play;
c. automatically activating an awards slider component if the outcome of the game play is a winning outcome, wherein the winning outcome comprises an associated award amount, and wherein activating the awards slider component causes animation of a dynamic slider feature graphic including an indicator dynamically moving along or about a slider scale on a display; and
d. interacting with the dynamic slider feature graphic to determine a percentage of the award amount to be awarded, wherein the percentage of the award amount to be awarded is entirely determined by a stop position of the indicator of the dynamic slider feature graphic on the slider scale upon interacting with the dynamic slider feature.

2. The method of claim 1, wherein the indicator comprises a slider pointer.

3. The method of claim 1, wherein the slider scale includes a defined percentage range.

4. The method of claim 2, wherein interacting with the dynamic slider feature graphic comprises actuating a user input, wherein actuating the user input stops the slider pointer at its position on the slider scale at the time the user input was actuated.

5. The method of claim 4, wherein the user input comprises any of one or more buttons and/or a touchscreen.

6. The method of claim 4, further including a timer, and wherein activating the awards slider component starts the timer, and the user input must be actuated within a set period of time or the entire award amount is forfeited.

7. The method of claim 6, wherein the slider pointer moves continuously along or about the slider scale until actuating the user input or expiration of the set period of time on the timer.

8. The method of claim 1, wherein the slider scale is arranged in one of a horizontal, vertical, or rotary fashion.

9. The method of claim 1, wherein initiating the game play comprises adding an amount of consideration to the game machine via a consideration input device.

10. The method of claim 1, wherein whether or not the awards slider component is automatically activated is solely dependent on the outcome of the initiated game play of the game.

11. The method of claim 1, wherein the game machine comprising one or more of a display, one or more user inputs, consideration input/payout device, a speaker, a ticket reader, a swipe/dunk card reader, and/or a ticket printer.

12. A system for determining an award amount, comprising:
a. a game machine;
b. a display associated with the game machine;
c. one or more user inputs associated with the game machine, wherein the one or more user inputs comprise either or both of a user input touch screen integrated with the display and/or one or more user input buttons, and wherein the one or more user input buttons comprise one or more of buttons, switches, dials, touch pad/surface, mouse, and/or joy stick;
d. a consideration input/payout device associated with the game machine, wherein the consideration input/payout device is configured to accept consideration input from a user and/or dispense an award;
e. an awards slider component; and
f. one or more controllers, wherein the one or more controllers are associated with one or more processors and associated with the display, the user inputs, the awards slider component, and the consideration/payout input device, and wherein the one or more processors comprising non-transitory computer readable medium including executable program code stored thereon, wherein upon execution of the executable program code the processors are configured to:
i. initiate a game play of a game;
ii. receive an outcome of the game play;
iii. automatically activate the awards slider component if the outcome of the game play is a winning outcome, wherein the winning outcome comprises an associated award amount, and wherein activating the awards slider component causes animation of a dynamic slider feature graphic, including an indicator, dynamically moving along or about a slider scale on the display; and
iv. receive a command interacting with the dynamic slider feature graphic to determine a percentage of the award amount to be awarded, wherein the command updates the display to cause the animation of the indicator of the dynamic slider feature graphic dynamically moving along or about the slider scale to stop at its current position along or about the slider scale, wherein the percentage of the award amount to be awarded is entirely determined by the position of the indicator where it was stopped on the slider scale.

13. The system of claim 12, wherein the indicator comprises a slider pointer.

14. The system of claim 12, wherein the slider scale includes a defined percentage range.

15. The system of claim 13, wherein interacting with the dynamic slider feature graphic comprises activating one or more of the one or more user inputs, wherein activating one or more of the one or more user inputs stops the slider pointer at its current position on the slider scale at the time one or more of the one or more user input was activated.

16. The system of claim 15, further including a timer, and wherein upon activating the awards slider component the timer is started, and the user input must be actuated within a set period of time or the entire award amount is forfeited.

17. The system of claim 16, wherein the slider pointer moves continuously along or about the slider scale until actuating the user input or expiration of the set period of time on the timer.

18. The system of claim 12, further comprising one or more of a speaker, a ticket reader, a swipe/dunk card reader, and/or a ticket printer.

19. The system of claim 12, wherein the slider scale is arranged in one of a horizontal, vertical, or rotary fashion.

20. The system of claim 12, wherein whether or not the awards slider component is automatically activated is solely dependent on the outcome of the initiated game play of the game.
